(19) United States
(12) Patent Application Publication
(10) Pub. No.: US 2016/0096740 A1
(43) Pub. Date: Apr. 7, 2016

(54) Drinking Water Filtering Device

(71) Applicant: Bassam Salloum, Little Neck, NY (US)

(72) Inventor: Bassam Salloum, Little Neck, NY (US)

(21) Appl. No.: 14/507,998

(22) Filed: Oct. 7, 2014

(51) Int. Cl. C02F 1/00

(52) U.S. Cl. CPC C02F 1/002; C02F 2307/02

(57) ABSTRACT

A drinking water filtering device filters drinking water being drunk from a beverage container. The device includes a housing having a peripheral wall defining an interior space. The housing has a bottom end and a top end, each of which is open. A filter is positioned in the interior space between the bottom end and the top end. A collar is coupled to and extends upwardly from the top end of the housing around the open end. The collar defines a socket configured for receiving an opening of a straw wherein the filter is configured for filtering water drawn through the interior space by sucking on the straw.

### BACKGROUND OF THE DISCLOSURE

### Field of the Disclosure

The disclosure relates to filter devices and more particularly pertains to a new filter device for filtering drinking water being drunk from a beverage container.

SUMMARY OF THE DISCLOSURE

An embodiment of the disclosure meets the needs presented above by generally comprising a housing having a peripheral wall defining an interior space. The housing has a bottom end and a top end, each of which is open. A filter is positioned in the interior space between the bottom end and the top end. A collar is coupled to and extends upwardly from the top end of the housing around the open end. The collar defines a socket configured for receiving an opening of a straw wherein the filter is configured for filtering water drawn through the interior space by sucking on the straw.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front perspective view of a drinking water filtering device according to an embodiment of the disclosure.

FIG. 2 is a detailed front view of a filter of an embodiment of the disclosure.

FIG. 3 is a top view of a filter of an embodiment of the disclosure.

FIG. 4 is a cross-sectional view of an embodiment of the disclosure taken along line 4-4 of FIG. 2.

FIG. 5 is a partial cut-away top front side perspective view of an alternate embodiment of the disclosure.

### DESCRIPTION OF THE PREFERRED EMBODIMENT

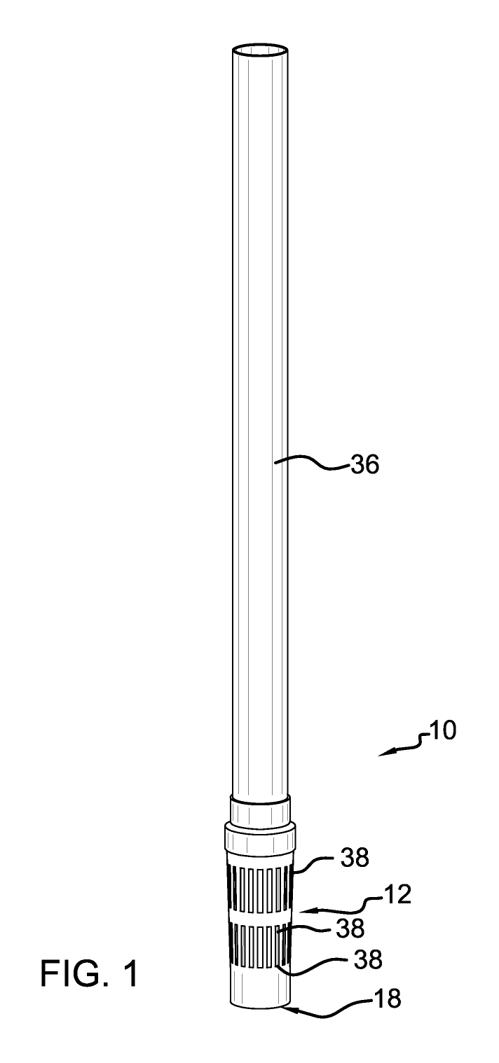

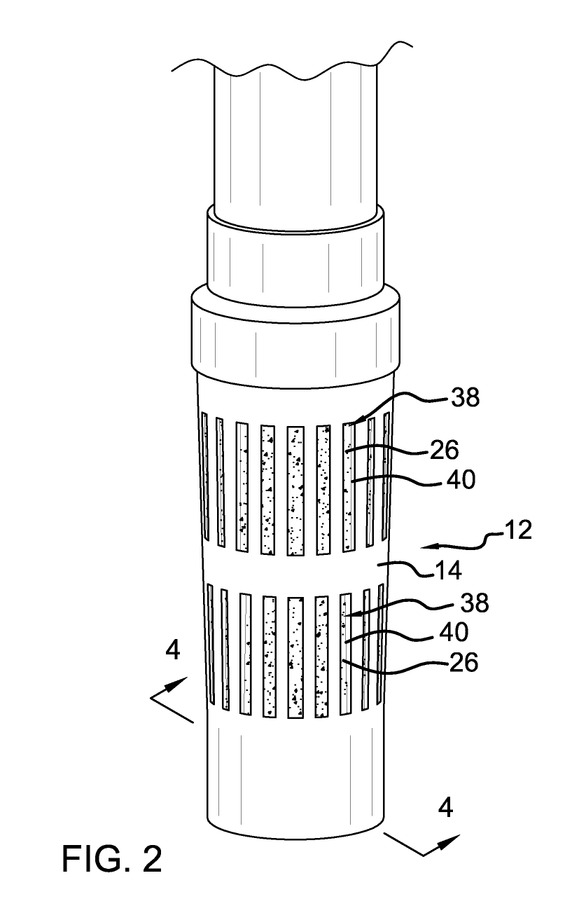

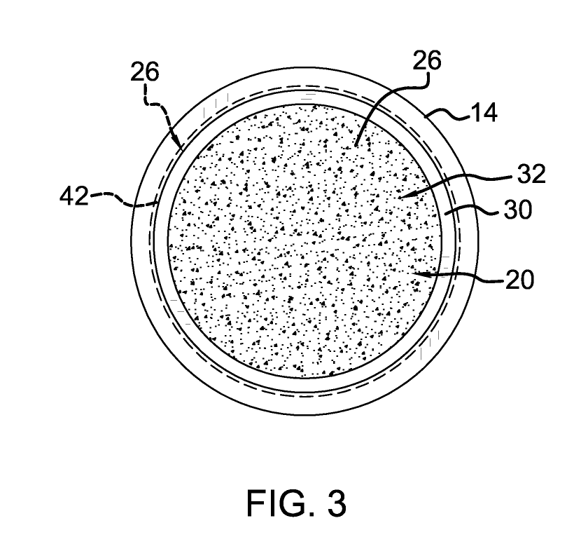

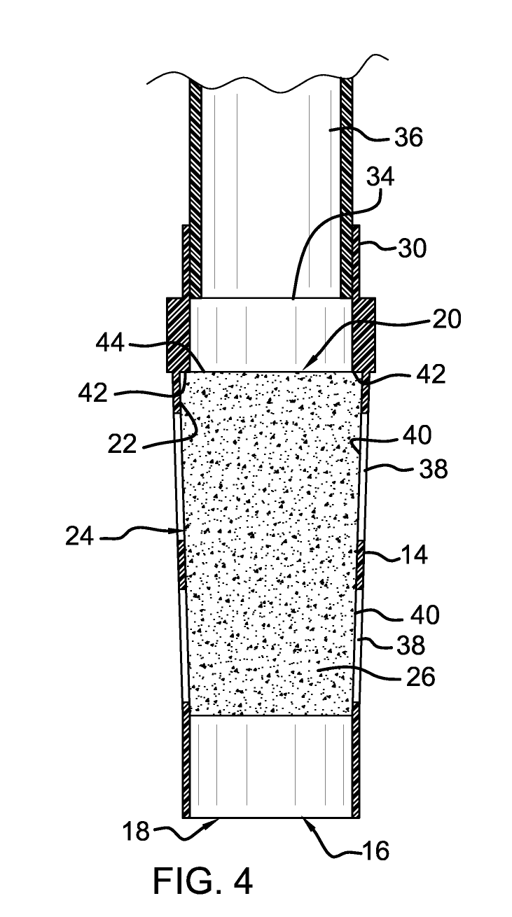

With reference now to the drawings, and in particular to FIGS. 1 through 5 thereof, a new filter device embodying the principles and concepts of an embodiment of the disclosure and generally designated by the reference numeral 10 will be described.

As best illustrated in FIGS. 1 through 5, the drinking water filtering device 10 generally comprises a housing 12 having a peripheral wall 14 defining an interior space 16. The housing 12 has a bottom end 18 and a top end 20. The bottom end 18 and the top end 20 are each open. An interior surface 22 of a medial section 24 of the peripheral wall 14 tapers inwardly extending away from the top end 20 and towards the bottom end 18. A filter 26 is positioned in the interior space 16 between the bottom end 18 and the top end 20. The filter 26 is frusto-conical wherein an outer surface 28 of the filter 26 abuts the interior surface 22 of the medial section 24 of the peripheral wall 14.

A collar 30 is coupled to and extends upwardly from the top end 20 of the housing 12. The collar 30 defines a socket 32 configured for receiving an opening 34 of a straw 36 wherein the filter 26 is configured for filtering water drawn through the interior space 16 by sucking on the straw 36.

A plurality of apertures 38 extends through the peripheral wall 14 of the housing 12. The apertures 38 are arranged radially around the peripheral wall 14. Each of the apertures 38 is rectangular. Each of the apertures 38 has a longitudinal axis coplanar with a longitudinal axis of the housing 12. The filter 26 abuts a perimeter edge 40 of each of the apertures 38.

An interior lip 42 extends inwardly from the peripheral wall 14 of the housing 12. The interior lip 42 abuts a top surface 44 of the filter 26. The interior lip 42 extends a full circumference around the interior surface 22 of the medial surface 24 of the peripheral wall 16.

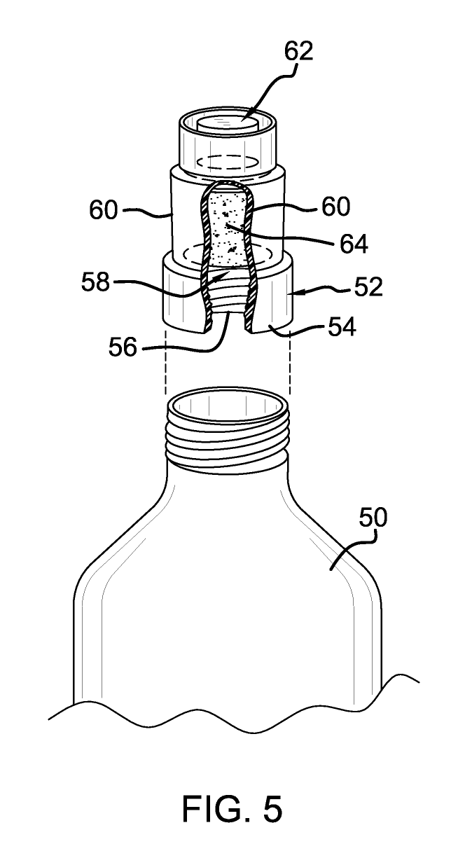

As shown in FIG. 5, an embodiment of the device 10 can be used with a conventional beverage container 50 of the type used for drinking water by providing a cap 52 having a circumferential wall 54. The circumferential wall 54 is threaded on an inwardly facing surface 56 wherein the cap 52 is configured for being coupled to the beverage container 50. The cap 52 has an open top 58. A perimeter wall 60 is coupled to and extends from the cap 52 around the open top 58. A spout 62 is coupled to a top 64 of the perimeter wall 60. The spout 62 is in fluid communication with the cap 52 through the open top 58 of the cap 52. A filter 64 is positioned in the perimeter wall 60 between the cap 52 and the spout 62 wherein the filter 64 is configured for filtering water passing through the perimeter wall 60 from the cap 52 to the spout 62. The spout 62 may open and close in a conventional manner. The cap 52 may include a seal or the like for engaging the beverage container 50 wherein water must pass through the filter 64 to reach the spout 62.

In use, the housing 12 is positioned at the opening 34 of the straw 36 by insertion of the straw 36 into the socket 32 defined by the collar 30. The straw 36 may be a pre- existing straw having a size complementary to a size of socket 32 provided or the straw 36 may be provided with and sized specifically to correspond to the socket 32 as part of the device 10. The device housing 12 is then positioned in the beverage, typically water. The straw 36 is used in a conventional manner drawing the beverage through the bottom end 18 and the apertures 38 and through the filter 26 before passing into the straw 36 for delivery to a mouth for consumption. As shown in FIG. 5, the filter 64 is positioned to receive water out of the beverage container 50 prior to delivery to the spout 62 for drinking. The cap 52 is configured to replace a conventional cap found on an existing water bottle. Thus, the water is filtered as it passes from the beverage container 50 to the spout 62.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A drinking water filtering device comprising:
a housing having a peripheral wall defining an interior space, said housing having a bottom end and a top end, said bottom end being open, said top end being open;
a filter positioned in said interior space between said bottom end and said top end; and
a collar coupled to and extending upwardly from said top end of said housing, said collar defining a socket configured for receiving an opening of a straw wherein said filter is configured for filtering water drawn through said interior space by sucking on the straw.

2. The device of claim 1, further comprising in interior surface of a medial section of said peripheral wall tapering inwardly extending away from said top end.

3. The device of claim 2, further comprising said filter being frusto-conical wherein an outer surface of said filter abuts said interior surface of said medial section of said peripheral wall.

4. The device of claim 1, further comprising a plurality of apertures extending through said peripheral wall of said housing.

5. The device of claim 4, further comprising said apertures being arranged radially around said peripheral wall.

6. The device of claim 4, further comprising each of said apertures being rectangular.

7. The device of claim 6, further comprising each of said apertures having a longitudinal axis coplanar with a longitudinal axis of said housing.

8. The device of claim 4, further comprising said filter abutting a perimeter edge of each of said apertures.

9. The device of claim 1, further comprising an interior lip extending inwardly from said peripheral wall of said housing, said interior lip abutting a top surface of said filter.

10. The device of claim 9, further comprising said interior lip extending a full circumference around said interior surface of said peripheral wall.

11. A drinking water filtering device comprising:
a housing having a peripheral wall defining an interior space, said housing having a bottom end and a top end, said bottom end being open, said top end being open, an interior surface of a medial section of said peripheral wall tapering inwardly extending away from said top end;
a filter positioned in said interior space between said bottom end and said top end, said filter being frusto-conical wherein an outer surface of said filter abuts said interior surface of said medial section of said peripheral wall;
a collar coupled to and extending upwardly from said top end of said housing, said collar defining a socket configured for receiving an opening of a straw wherein said filter is configured for filtering water drawn through said interior space by sucking on the straw;
a plurality of apertures extending through said peripheral wall of said housing, said apertures being arranged radially around said peripheral wall, each of said apertures being rectangular, each of said apertures having a longitudinal axis coplanar with a longitudinal axis of said housing, said filter abutting a perimeter edge of each of said apertures; and
an interior lip extending inwardly from said peripheral wall of said housing, said interior lip abutting a top surface of said filter, said interior lip extending a full circumference around said interior surface of said peripheral wall.

12. A drinking water filtering device comprising:
a cap having a circumferential wall, said circumferential wall being threaded on an inwardly facing surface wherein said cap is configured for being coupled to a beverage container, said cap having an open top;
a perimeter wall coupled to and extending from said cap around said open top;
a spout coupled to a top of said perimeter wall, said spout being in fluid communication with said cap through said open top of said cap; and
a filter positioned in said perimeter wall between said cap and said spout wherein said filter is configured for filtering water passing through said perimeter wall from said cap to said spout.
